(19) United States
(12) Patent Application Publication
(10) Pub. No.: US 2007/0006429 A1
(43) Pub. Date: Jan. 11, 2007

(54) Fitting for wire rope

(75) Inventors: Joseph L. Huffman, Mukwonago, WI (US); Harvey J. Kallenberger, Wind Lake, WI (US); Rikos A. Kasim, Mukwonago, WI (US)

Correspondence Address: JAMES EARL LOWE, JR., 15417 W NATIONAL AVE # 300, NEW BERLIN, WI, 53151, US

(73) Assignee: Harnischfeger Technologies, Inc.

(21) Appl. No.: 11/177,463

(22) Filed: Jul. 8, 2005

(51) Int. Cl. F16G 11/00

(52) U.S. Cl. 24/136 R

(57) ABSTRACT

An end fitting for a wire rope with a diameter, the fitting being adapted to securely hold and to attach the wire rope to a structure, the end fitting comprising a stiff support having a support first end adapted to be connected to the structure and a support second end adapted to securely hold the wire rope end. The end fitting further includes an elongated flexible enclosure surrounding the wire rope, the flexible enclosure having a length more than 2 times longer than the diameter. The flexible enclosure has a first enclosure end and a second enclosure end, the enclosure being attached to the stiff support by the first enclosure end surrounding and holding the support second end.

### BACKGROUND OF THE INVENTION

This invention relates to fittings for attaching a metallic wire rope or structural strand end (both hereinafter referred to as a rope) to a support.

It is well known to provide a socket end fitting which is permanently anchored to the end of the rope by the latter being received within a through bore of the fitting with the strands of the rope preferably being spread within a divergent part of said bore, the end being secured therein by running molten solder spelter into the bore through the end remote from the main part of the rope, or by clamping the end of the wire rope within the fitting.

On mobile lifting and excavating equipment, one such type of equipment being a dragline, the ropes that extend between the A-frame and the mast and between the mast and the boom are usually attached to the structures (A-frame, mast and boom) by such a socket fitting. The constant change in the tension in the strands results in the wire rope oscillating up and down (and sideways to an extent). Since the socket fitting is so much heavier per unit length and stiffer than the wire rope, the wire rope will bend at the point where it exits the socket fitting. This will eventually lead to wire breakage and, ultimately, rope failure. To reduce the amount of wire breakage where the rope exits the socket fitting, the rope manufacturers have come up with a damper design which basically is a cylindrical piece of steel about several rope diameters in length that surrounds the wire rope and that is bolted to a flange on the socket fitting. In between the damper and the socket fitting is a non-metallic material that is like a thick soft gasket. The wire rope extends through the damper and the gasket before it enters the fitting. In theory, the gasket will compress to ‘damp’ the motion of the strands in the wire rope. This however has not been very successful in extending the useful life of the rope an appreciable amount.

### SUMMARY OF THE INVENTION

One of the principal objects of the invention is to provide a fitting that allows for a nice gradual stiffness change between the wire rope and the socket fitting, thereby reducing the amount of wire damage and increasing the useful life of the wire rope.

More particularly, the invention is in the form of a fitting for a wire rope with a diameter, the fitting being adapted to securely hold and to attach the wire rope to a structure, the end fitting comprising a stiff support having a support first end adapted to be connected to the structure and a support second end adapted to securely hold the wire rope end. The end fitting further includes an elongated flexible enclosure surrounding the wire rope, the flexible enclosure having a length more than 2 times longer than the diameter. The flexible enclosure has a first enclosure end and a second enclosure end, the enclosure being attached to the stiff support by the first enclosure end surrounding and holding the support second end.

### BRIEF DESCRIPTION OF THE DRAWINGS

FIG. 1 is a perspective view of the fitting for a wire rope in accordance with this invention.

FIG. 2 is a top view of a horizontal cross section of the fitting shown in FIG. 1.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience in reference to the drawings and are not to be construed as limiting terms.

### DETAILED DESCRIPTION OF THE PREFERRED EMBODIMENT

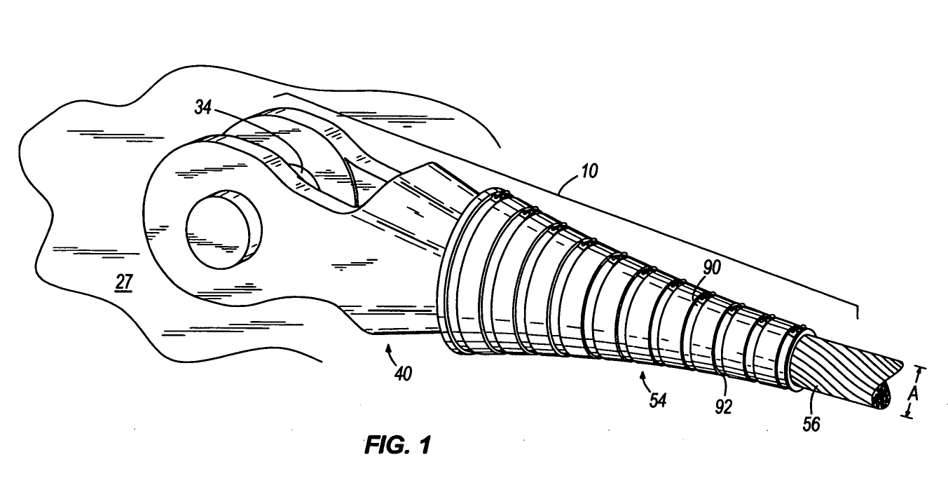

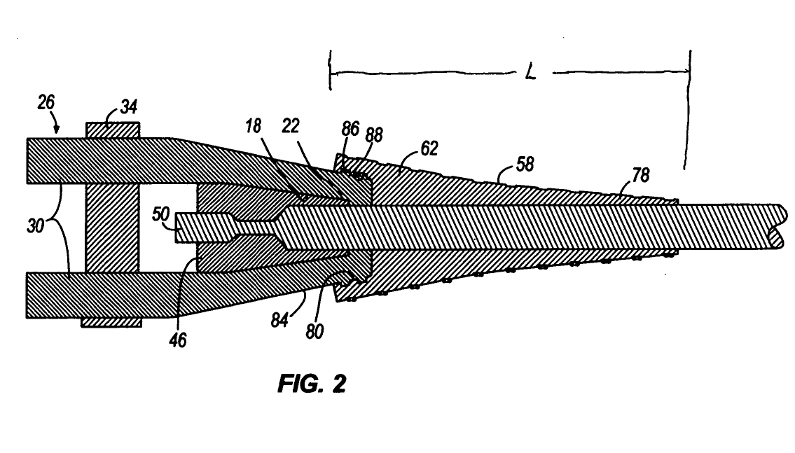

As illustrated in FIGS. 1 and 2, the invention is a fitting 10. The fitting 10 includes a stiff support 40 and an elongated flexible enclosure 54 adapted to surround a wire rope 56 with a diameter A, as shown in FIG. 1. The fitting 10 is adapted to hold and to attach the wire rope 56 to a structure 27.

In the illustrated embodiment, the support bracket 40 is in the form of a conventional anchor or support bracket intended to be secured by a clevis pin 34 to a lug (not shown) on the structure 27, such as a dragline, a mining shovel, or other equipment where a wire rope can be subjected to loads that could result oscillatory movement of the wire rope relative to the fitting.

More particularly, the support bracket 40 is in the form of a conventional frusto-conical socket fitting. As shown in FIG. 2, the support bracket 40 has a through passage, with one end having an internal tapered socket 18, with the narrow end of the socket 18 at a second end 22 of the support bracket 40. The first end 26 of the support bracket 40 forms two spaced-apart clevis ears 30, with two aligned openings through the ears 30 that receive the clevis pin 34. In other embodiments (not shown), other open or closed end support brackets can be used.

Various means can be used to secure the end of the wire rope 56 in the support bracket socket 18. In the illustrated embodiment, as shown in FIG. 2, a tapered split clamp 46 fits inside the tapered socket 18 and holds the wire rope end 50. The socket 18 holds the two clamp pieces 46 together and causes the clamp collar 46 to hold the wire rope end 50. In another embodiment (not shown), the end of the wire rope can be anchored in the anchor bore by having its strands splayed and secured in a known manner by spelter or a non-metallic compound with access for this purpose through the open distal portion of the bore.

The support bracket 40 is made of a metal, such as steel. In other embodiments, the support bracket 40 can be made of any material stiffness substantially greater than that of the flexible enclosure 54.

The flexible enclosure 54 has a length more than 2 times longer than the diameter A and a first enclosure end 62 and a second enclosure end 78, the enclosure being attached to the support bracket 40 by the first enclosure end 62 surrounding and holding the support second end 22.

More particularly, the flexible enclosure 54 has a length L (as shown in FIG. 2) more than 2 times longer than the diameter A of the wire rope. Still more particularly, in the preferred embodiment, the flexible enclosure 54 is at least 6.5 times the diameter A of the wire rope, or about 32 inches (51.5 cm) long, and the wire rope diameter is about 4.75 (12.1 cm) inches. The enclosure outer surface 58 is tapered, and the larger end 62 of the tapered enclosure 54 is attached to the socket bracket 40 by enclosure attaching means in the form of the larger end 62 of the tapered enclosure 54 having an inside tapered bore 80 that mates with an exterior tapered surface 84 on the support bracket 40. The exterior tapered surface 84 of the second end 22 of the support bracket 40 also includes ribs 86, and the ribs 86 are received in mating channels 88 in the tapered inside bore 80 of the first enclosure end 62.

In the preferred embodiment, the flexible enclosure 54 is made of an elastomer toughened thermoplastic material. More particularly, the flexible enclosure 54 is made of two components mixed together and cured, the two components comprising one component made of caprolactam and a prepolymer in the form of a polyl based on polyether. The other component is made of a curing catalyst and caprolactam. Still more particularly, the flexible enclosure 54 is made from Nyrim 2000 or Nyrim 3000, a trademarked material sold by Bruggemann Chemical.

The enclosure 54 is made in 2 halves so that the two halves can be installed on existing fitting assemblies. The enclosure halves are placed over the wire rope 56 and the support bracket 40 and are held together by band clamps 90 (see FIG. 1) secured around and received in grooves 92 on the halves. In other embodiments (not shown), the flexible enclosure can include radially extending flanges to secure the two halves of the flexible enclosure together.

In still other embodiments (not shown), the flexible enclosure 54 can be a hollow solid (not split) cone or cylinder (or other tapered shape) slipped over the end of the wire rope 56 and the support bracket end 22.

Various other features and advantages of the invention will be apparent from the following claims.

1. An end fitting for a wire rope with a diameter, the fitting being adapted to securely hold and to attach the wire rope to a structure, the end fitting comprising a stiff support having a support first end adapted to be connected to the structure and a support second end adapted to securely hold the wire rope end,
an elongated flexible enclosure surrounding the wire rope, said flexible enclosure having a length more than 2 times longer than said diameter and a first enclosure end and a second enclosure end, and
means for attaching the enclosure to the stiff support comprising said first enclosure end surrounding and holding said support second end.

2. An end fitting in accordance with claim 1 wherein said flexible enclosure is made of an elastomer toughened thermoplastic material and said support is made of steel.

3. An end fitting in accordance with claim 2 wherein said flexible enclosure is made of two components mixed together and cured, the two components comprising one component made of caprolactam and a prepolymer in the form of a polyl based on polyether, and the other component made of a curing catalyst and caprolactam.

4. An end fitting in accordance with claim 1 wherein said flexible enclosure is split into two pieces that are adapted to be secured together around the wire rope.

5. An end fitting in accordance with claim 4 wherein said enclosure is a cone split into two pieces adapted to be placed over the wire rope, and wherein said enclosure further includes means for securing the enclosure split pieces together.

6. An end fitting in accordance with claim 1 wherein said wire rope has a diameter, and wherein said flexible enclosure has a length more than 6.5 times longer than said diameter.

7. An end fitting for a wire rope with a diameter, the fitting being adapted to securely hold and to attach the wire rope to a structure, the end fitting comprising a stiff support having a support first end adapted to be connected to the structure and a support second end adapted to securely hold the wire rope end,
a tapered elongated flexible enclosure surrounding the wire rope, said flexible enclosure having a length more than 2 times longer than said diameter and a first larger enclosure end and a second smaller enclosure end, and
means for attaching the enclosure to the stiff support comprising said first enclosure end surrounding and holding said support second end.

8. An end fitting in accordance with claim 7 wherein said means for attaching the larger end of the tapered enclosure to the stiff support comprises said flexible enclosure having an inside tapered bore that mates with the exterior tapered surface on the stiff support.

9. An end fitting in accordance with claim 7 wherein said wire rope has a diameter, and wherein said flexible enclosure has a length more than 6.5 times longer than said diameter.

10. An end fitting in accordance with claim 9 wherein said flexible enclosure is made of an elastomer toughened thermoplastic material and said support is made of steel.

11. An end fitting in accordance with claim 9 wherein said flexible enclosure is made of two components mixed together and cured, the two components comprising one component made of caprolactam and a prepolymer in the form of a polyl based on polyether, and the other component made of a curing catalyst and caprolactam.
